(19) United States
(12) Patent Application Publication
(10) Pub. No.: US 2015/0114308 A1
(43) Pub. Date: Apr. 30, 2015

(54) Dog Jump Apparatus

(71) Applicant: Craig Heath Dolphin, Ferndale, WA (US)

(72) Inventor: Craig Heath Dolphin, Ferndale, WA (US)

(21) Appl. No.: 14/526,374

(22) Filed: Oct. 28, 2014

Related U.S. Application Data
(60) Provisional application No. 61/897,625, filed on Oct. 30, 2013.

(51) Int. Cl. A63K 3/04; A01K 15/02

(52) U.S. Cl. CPC A63K 3/04; A01K 15/027
USPC 119/705

(57) ABSTRACT

A dog jump apparatus having stanchions that are magnetically attached to a base and/or jump cups that are magnetically attached to stanchions is described. In some embodiments, the dog jump apparatus includes a base, a first stanchion magnetically fixed to a first end of the base, the first stanchion having at least one jump cup magnetic attachment point, a second stanchion magnetically fixed to a second, opposite, end of the base, the first stanchion having at least one jump cup magnetic attachment point, a first jump cup that magnetically attaches to the at least one magnetic attachment point of the first stanchion, a second jump cup that magnetically attaches to the at least one magnetic attachment point of the second stanchion, and a jump bar supported by the first jump cup and the second jump cup.

### CROSS REFERENCE TO RELATED APPLICATIONS

This application claims priority to U.S. Provisional Patent Application No. 61/897,625, filed on Oct. 30, 2013, entitled A BAR JUMP FOR DOG SPORTS WITH STANCHIONS THAT ARE MAGNETICALLY ATTACHED TO THE BASE, which is incorporated by reference in its entirety.

### BACKGROUND

Existing one-piece dog jumps have stanchions that are mechanically fixed or welded to the base. Existing two-piece dog jumps have stanchions with separate external supporting structures. One-piece jumps can potentially cause injury if a dog or handler collides with the mechanically affixed stanchions. Two-piece jumps are more inconvenient for setting up on uneven ground to ensure that the correct distance between the stanchions is achieved, and to ensure that the stanchions are parallel with each other and perpendicular to the ground. Additionally, their external support structures can create path obstructions for small dogs that want to turn close-in to the stanchion.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example dog jump apparatus having stanchions magnetically attached to a base.

FIG. 2 is a front view of the dog jump apparatus.

FIG. 3 shows another example of the dog jump apparatus.

FIG. 4 is a view taken from line 1-1 of FIG. 2.

### DETAILED DESCRIPTION

### Overview

A dog jump apparatus having stanchions that are magnetically attached to a base and/or jump cups that are magnetically attached to stanchions is described. In some embodiments, the dog jump apparatus includes a base, a first stanchion magnetically fixed to a first end of the base, a second stanchion magnetically fixed to a second, opposite, end of the base, at least one first jump cup attached to the first stanchion, at least one second jump cup attached to the second stanchion, and a jump bar supported by the first jump cup and the second jump cup.

In some embodiments, the dog jump apparatus includes a base, a first stanchion magnetically fixed to a first end of the base, the first stanchion having multiple magnetic attachment points located at various jump bar positioning heights, a second stanchion magnetically fixed to a second, opposite, end of the base, the second stanchion having multiple magnetic attachment points located at the various jump bar positioning heights, a first jump cup that magnetically attaches to the at least one magnetic attachment point of the first stanchion, a second jump cup that magnetically attaches to the at least one magnetic attachment point of the second stanchion, and a jump bar supported by the first jump cup and the second jump cup and positioned at one of the various jump bar positioning heights.

In some embodiments, a method of supporting a jump bar includes magnetically attaching a first stanchion to a first end of a base, the first stanchion having a first jump cup attached to the stanchion, magnetically attaching a second stanchion to a second end of the base, the second stanchion having a second jump cup attached to the stanchion, and positioning the jump bar on the first jump cup and the second jump cup.

### Examples of the Dog Jump Apparatus

Examples of the dog jump apparatus described herein may include a base with positioning guides and magnetically affixed stanchions at each end. The solid base maintains a proper spacing and alignment between the stanchions. The stanchions break away from the base when impacted, minimizing the chance of injury to a dog or owner. The magnetic attachment does not require external supports for the stanchions, leaving a clear path for the dog.

The magnetic attachment of the stanchions to the steel base means enables lightweight stanchions to move and fall over when they are impacted by a dog or handler, thereby reducing the likelihood of injury. The use of a single fixed-width base, with permanent positioning guides, ensures that the correct distance is always maintained between the stanchions. The magnets encapsulated within the flat-ended stanchion keep the stanchions perpendicular to the jump base even when the ground is uneven under parts of the base. Also, because the magnets keep the stanchions upright, there is no need for other external support structures, and thus there are no external structure that may impede the path of a dog that is turning close-in to the stanchions.

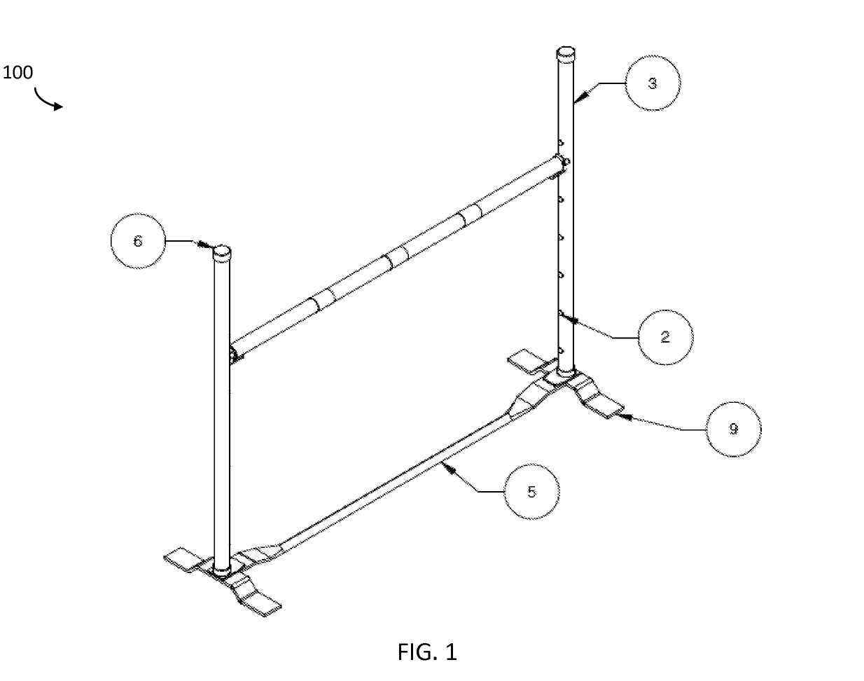

FIGS. 1, 2, and 3 depict various examples of the dog jump apparatus 100, having stanchions magnetically attached to a base, described herein. The dog jump apparatus may include a base 5, such as a steel base, approximately 52 inches long, with perpendicular feet at each end of a longitudinal member made of ¾ inch angle iron, and steel feet 9, such as two steel feet that are 13 inches long and 2 inches wide with a 3 inch long central section that is raised approximately 1 inch above the ground and welded to a central portion of the base using a transitional piece of 1 inch steel.

The dog jump apparatus may also include a first stanchion 3 magnetically fixed to a first end of the base 5, the first stanchion 3 having at least one jump cup magnetic attachment point 2, and a second stanchion 3 magnetically fixed to a second, opposite, end of the base 5, the second stanchion 3 having at least one jump cup magnetic attachment point 2. The stanchions 3 may be formed as stanchion tubes made out of 1-inch schedule 40 PVC pipes that are 32 inches long, and may include stanchion end caps 6 made of thin plastic or rubber. The magnetic attachment points 2 may include steel washers or other ferrous metals, which provide magnetically active attachment points at different heights on the stanchions 3.

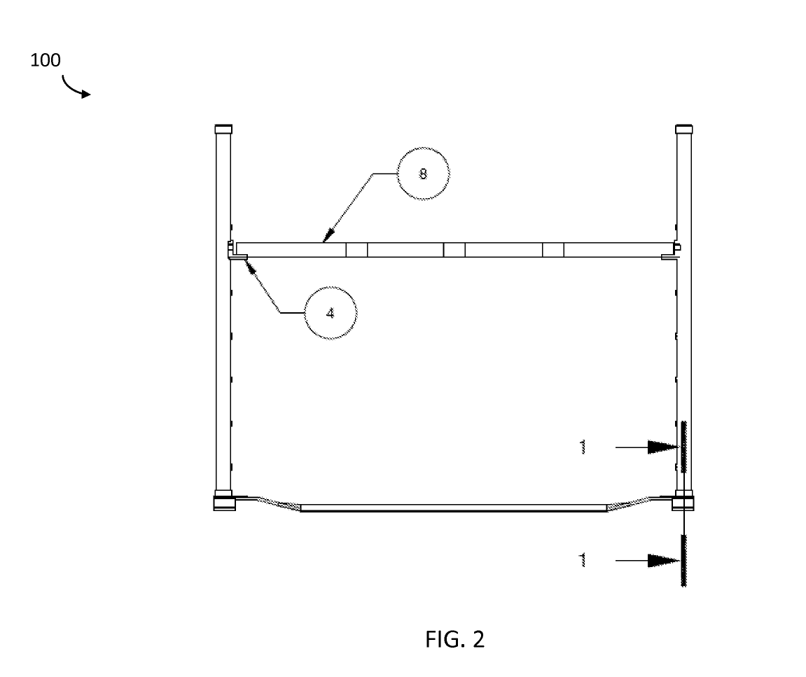

The dog jump apparatus also includes jump cups 4 that function to support each end of a jump bar 8 when affixed to the stanchions 3. In some embodiments, such as the apparatus depicted in FIGS. 1 and 2, a first jump cup 4 magnetically attaches to the magnetic attachment point 2 of the first stanchion 3, and a second jump cup 4 magnetically attaches to the magnetic attachment point 2 of the second stanchion 3.

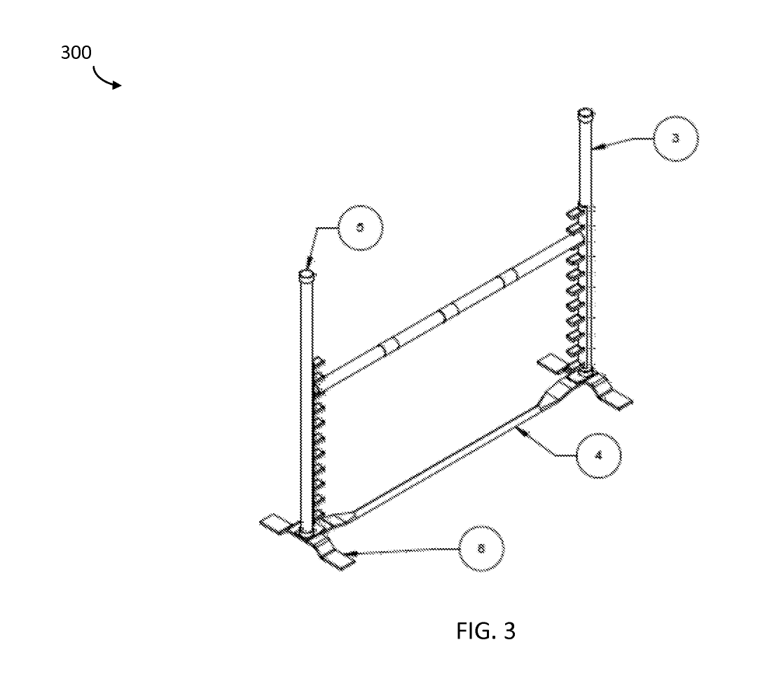

In other embodiments, such as the apparatus depicted in FIG. 3, the jump cups may be securely fixed to the stanchions 3. For example, the jump cups may be part of jump cup strips that are fixed, via fasteners, to the stanchions.

The jump bar 8 is supported by the first jump cup 4 and the second jump cup 4, and may be a 4-foot jump bar made of Schedule 40 PVC, and striped with colored tape or paint to provide a visual contrast.

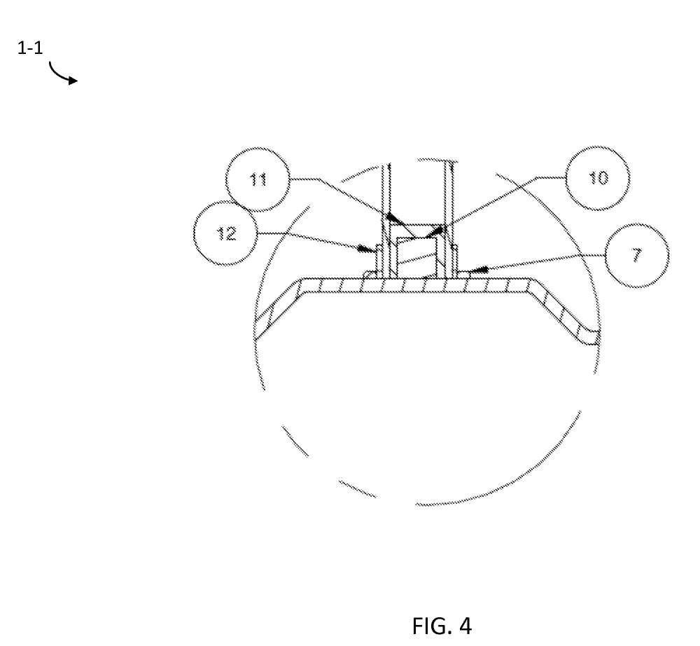

As described herein, the dog jump apparatus 100 includes stanchions 3 that are magnetically fixed or magnetically attached to the base 5. FIG. 4 shows a view taken along line 1-1 of FIG. 2, which depicts the components of the stanchions utilized to magnetically fix the stanchions 3 to the base 5 of the dog jump apparatus 100.

As depicted in the Figure, the dog jump apparatus 100 includes stanchion positioning guides 7 that assist in positioning the stanchion in an upright position on the base 5. The stanchion positioning guides may be fixed to the base 5 and may have a circular opening that is 1.5 inches in diameter and made of 1/4-inch thick plastic, among other geometries.

The stanchions 3 may include stanchion magnets 10, which may be disc-shaped Neodymium rare-earth magnets that have a 15/16 inch diameter and are 1/2 inch thick, an encapsulation component 11, such as an epoxy or pourable plastic, to affix and encapsulate the base magnets 10 within the stanchions 3, and open-ended stanchion end caps 12, such as caps made of PVC, that allow the magnet to contact the base 5.

For example, the positioning guides 7 may be placed, positioned, or fixed on each end of the metal base 5 so that the dimension between the inside of the circular openings of the two guides 7 is equal to the width of the jump bar 8 plus an allowance for the thickness of the jump cups 4 that the jump bar rests on. Once in position, the guides 7 are affixed to the base with pop rivets or other fasteners.

The stanchion magnet 10 is placed inside the bottom of the stanchion 3 (e.g., inside a stanchion tube). The magnet 10 is located in the center of the tube and flush with the bottom of the stanchion 3, as shown. The magnet 10 is then encapsulated with a suitable epoxy resin 11 or pourable plastic, thereby affixing it inside the stanchion 3. A flat-ended end cap 6 is then affixed to the top of the stanchion 3, and an open-ended cap 12 is affixed to the bottom of the stanchion 3, so that the magnet 10 can make contact with the base 5.

Multiple steel washers 2 are then lined up and positioned along each stanchion 3 so that when the magnetic jump cups 4 are attached to the washers, the top of the bar will end up within 1/4 inch of the height classes specified for use in dog agility and/or obedience. Once the washer positions are correct, then they are affixed to the stanchion 3 using a pop rivet or other fastener.

The completed stanchions 3 are then placed into the circular opening in the guides 7 on the base 5, and are magnetically attracted to the steel base 5, so that they stand vertically. On each stanchion 3, a magnetic jump cup 4 is then attached to the steel washer that corresponds to a desired height class. In some cases, the jump cups 4 may include a strap or other device that removable fixes the jump cups to the stanchions 3 while allowing the jump cups 4 to move during an impact to the stanchion 3. For example, the device may prevent the jump cups from completely detaching from the stanchions 3 when they are partially detached (e.g., their magnetic attachment is broken) by a dislodged bar or impacted stanchion. Finally, the jump bar 8 is placed on top of the supporting part of the jump cup.

During or before use, such as before a dog jumping event or exercise, the steel base 5 is placed on the ground and the stanchions 3 are placed so that the magnetic end is in the circular opening of the positioning guides 7. The magnets 10 in the flat-bottomed stanchions 3 are powerfully attracted to the steel in the base 5, which maintains the lightweight stanchions 3 in a perpendicular or vertical position with respect to the base 5, and parallel with each other.

However, if a moderately small force is applied to the side of the stanchion 3 (e.g., a dog or handler contacts or impacts the stanchion) then the leverage created by the stanchion 3 pivoting on its base 5 allows for the magnetic attraction of the magnets to be overcome, and the stanchion 3 can then easily fall away from the direction of the impact without disturbing the steel base 5 or the other stanchion 3. Because the impacted stanchion 3 falls away without disturbing other components of the dog jump apparatus 100, the mass involved in the collision is smaller, and less force is experienced by the dog or handler when they collide with the jump, decreasing the chance of injury.

Of course, the dog jump apparatus 100, the stanchions 3, the jump bar 8, and the jump cups 4 may be formed having a variety of different configurations and/or geometries. For example, the stanchions 3 may be configured as square or rectangular tubes, the magnetic attachment points 2 may be formed of other metal materials and/or devices, and so on. In addition, other types of jump apparatuses, such as spread jumps (e.g., triple-bar jumps, double-bar jumps, and so on), regular jumps with one, two, or more bars, panel jumps, and so on, may include the magnetically attached stanchions and/or jump cups described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the apparatus is not intended to be exhaustive or to limit the apparatus to the precise form disclosed herein. While specific embodiments of, and examples for, the apparatus are described above for illustrative purposes, various equivalent modifications are possible within the scope of the apparatus, as those skilled in the relevant art will recognize.

While certain aspects of the apparatus are presented below in certain claim forms, the inventors contemplate the various aspects of the apparatus in any number of claim forms. Accordingly, the inventors reserve the right to add additional claims after filing the application to pursue such additional claim forms for other aspects of the apparatus.

What is claimed is:

1. A dog jump apparatus, comprising:
a base;
a first stanchion magnetically fixed to a first end of the base;
a second stanchion magnetically fixed to a second, opposite, end of the base;
at least one first jump cup attached to the first stanchion;
at least one second jump cup attached to the second stanchion; and
a jump bar supported by the at least one first jump cup and the at least one second jump cup.

2. The dog jump apparatus of claim 1, wherein the at least one first jump cup is magnetically attached to the first stanchion, and wherein the at least one second jump cup is magnetically attached to the second stanchion.

3. The dog jump apparatus of claim 2, wherein each of the stanchions include magnetic attachment points having a ferrous metal disc fixedly attached to the stanchion, and wherein the at least one first jump cup and the at least one second jump cup include a magnet configured to magnetically attach a jump cup to a magnetic attachment point and a plastic or rubber support portion configured to support a jump bar.

4. The dog jump apparatus of claim 2, wherein the first stanchion and the second stanchion have multiple magnetic attachment points, each of the magnetic attachment points placed at different vertical heights on the stanchions.

5. The dog jump apparatus of claim 1, wherein the base is made of steel, wherein the first stanchion and the second stanchion include a magnet located at a bottom portion of the stanchions, and wherein the base includes stanchion positioning guides configured to assist in magnetically attaching stanchions to the base.

6. The dog jump apparatus of claim 1, wherein the at least first jump cup is part of a jump cup strip that is fixed to the first stanchion via a fastener, and wherein the at least second jump cup is part of a jump cup strip that is fixed to the second stanchion via a fastener.

7. A dog jump apparatus, comprising:
a base;
a first stanchion magnetically fixed to a first end of the base, the first stanchion having multiple magnetic attachment points located at various jump bar positioning heights;
a second stanchion magnetically fixed to a second, opposite, end of the base, the second stanchion having multiple magnetic attachment points located at the various jump bar positioning heights;
a first jump cup that magnetically attaches to the at least one magnetic attachment point of the first stanchion;
a second jump cup that magnetically attaches to the at least one magnetic attachment point of the second stanchion; and
a jump bar supported by the first jump cup and the second jump cup and positioned at one of the various jump bar positioning heights.

8. The dog jump apparatus of claim 7, wherein the various jump bar positioning heights include one or more vertical heights associated with a dog height class.

9. The dog jump apparatus of claim 7, wherein the base is made of steel, wherein the first stanchion and the second stanchion include a magnet located at a bottom portion of the stanchions, and wherein the base includes stanchion positioning guides configured to assist in magnetically attaching stanchions to the base.

10. A method of supporting a jump bar in a horizontal position, the method comprising:
magnetically attaching a first stanchion to a first end of a base, the first stanchion having a first jump cup attached to the first stanchion;
magnetically attaching a second stanchion to a second end of the base, the second stanchion having a second jump cup attached to the second stanchion;
positioning the jump bar on the first jump cup and the second jump cup.

11. The method of claim 10, wherein the jump cups are magnetically attached to the first stanchion and the second stanchion.

12. The method of claim 10, wherein the first jump cup is part of a jump cup strip that is attached to the first stanchion, and wherein the second jump cup is part of a jump cup strip that is attached to the second stanchion.
